(19) United States
(12) Patent Application Publication
(10) Pub. No.: US 2022/0210854 A1
(43) Pub. Date: Jun. 30, 2022

(54) Fixed Broadband Wireless Access CPE with Embedded IoT Gateways

(71) Applicant: Google LLC, Mountain View, CA (US)

(72) Inventors: Cedric Fung Lam, San Carlos, CA (US); Milo Steven Medin, Redwood City, CA (US)

(73) Assignee: Google LLC, Mountain View, CA (US)

(21) Appl. No.: 17/563,708

(22) Filed: Dec. 28, 2021

Related U.S. Application Data
(60) Provisional application No. 63/132,139, filed on Dec. 30, 2020.

(51) Int. Cl. H04W 76/16

(52) U.S. Cl. CPC H04W 76/16; H04W 88/16

(57) ABSTRACT

A computer-implemented method when executed by data processing hardware of customer premises equipment installed at an exterior portion of a premises of a user causes the data processing hardware to perform operation. The operations include receiving, via a local area network associated with the user, a first communication from a user device located within an interior of the premises of the user. The operations also include receiving, via a low-power wide area network, a second communication from a low-power device located exterior of the premises of the user. The operations also include transmitting, via a broadband connection using a fixed wireless access network, the first communication and the second communication to a remote server.

### CROSS REFERENCE TO RELATED APPLICATIONS

This U.S. patent application claims priority under 35 U.S.C. § 119(e) to U.S. Provisional Application 63/132,139, filed on Dec. 30, 2020. The disclosure of this prior application is considered part of the disclosure of this application and is hereby incorporated by reference in its entirety.

### TECHNICAL FIELD

This disclosure relates to fixed broadband wireless access with customer premise equipment (CPE) embedded with Internet of Things (IoT) gateways.

### BACKGROUND

Current residential Internet of Things (IoT) devices are generally communicating via indoor personal area network (PAN) and home area network (HAN) wireless technologies such as Wi-Fi, Zigbee, and Z-wave. Some IoT devices (e.g. smart meters, automated sprinklers, pet trackers, etc.) do not require high bandwidth but do require longer transmission distances and low power consumptions (i.e., because the devices are battery powered). Currently, this market is addressed by low-power wide area network (LPWAN) technologies such as IEEE 802.15.4g, Wi-SUN, LoRaWAN, SigFox, etc., and therefore is not accessed through Wi-Fi or other in-home networks. Information collected through the IoT devices generally must be backhauled to a cloud backend for processing, which also provides an end-user user device interface through an application.

### SUMMARY

One aspect of the disclosure provides a computer-implemented method for providing fixed broadband wireless access customer premises equipment (CPE) with embedded Internet of Things (IoT) gateways. The method, when executed by data processing hardware of customer premises equipment installed at an exterior portion of a premises of a user causes the data processing hardware to perform operations. The operations include receiving, via a local area network associated with the user, a first communication from a user device located within an interior of the premises of the user. The operations include receiving, via a low-power wide area network, a second communication from a low-power device located exterior of the premises of the user. The operations also include transmitting, via a broadband connection using a fixed wireless access network, the first communication and the second communication to a remote server.

Implementations of the disclosure may include one or more of the following optional features. In some implementations, the fixed wireless access network includes a 5G baseline network. Optionally, the operations further include receiving, via the low-power wide area network, a plurality of communications from a plurality of low-power devices located exterior of the premises of the user and transmitting, via the broadband connection using the fixed wireless access network, the plurality of communications to one or more remote servers.

In some examples, the low-power wide area network includes a low power long-range (LoRa) network. In some implementations, the operations further include receiving, via a smart utility network, a third communication from a utility device and transmitting, via the broadband connection using the fixed wireless access network, the third communication to a second remote server. In these implementations, the smart utility network may include a Wi-SUN network.

Optionally, the customer premises equipment is powered via power over Ethernet (PoE) from the premises of the user. The user device may include a smart home device. In some examples, the operations further include configuring a configurable transceiver to communicate via the low-power wide area network. In some implementations, transmitting the first communication and the second communication to the remote server includes determining an optimal transmit time to minimize interference.

In some examples, the operations further include receiving, via the low-power wide area network, an error condition from a remote customer premises equipment and transmitting, to the remote server, the error condition of a network connected to the remote customer premises equipment using the fixed wireless access network. The operations may further include receiving, via the low-power wide area network, diagnostic information from the low-power device and transmitting, via the fixed wireless access network, to the remote server, the diagnostic information, the diagnostic information, when received by the remote server, configured to cause the remote server to analyze the diagnostic information using a model. Optionally, the second communication is received via software defined radio.

Another aspect of the disclosure provides a system for providing fixed broadband wireless access customer premises equipment with embedded Internet of Things gateways. The system includes data processing hardware and memory hardware in communication with the data processing hardware. The memory hardware stores instructions that when executed on the data processing hardware cause the data processing hardware to perform operations. The operations include receiving, via a local area network associated with the user, a first communication from a user device located within an interior of the premises of the user. The operations include receiving, via a low-power wide area network, a second communication from a low-power device located exterior of the premises of the user. The operations also include transmitting, via a broadband connection using a fixed wireless access network, the first communication and the second communication to a remote server.

This aspect may include one or more of the following optional features. In some implementations, the fixed wireless access network includes a 5G baseline network. Optionally, the operations further include receiving, via the low-power wide area network, a plurality of communications from a plurality of low-power devices located exterior of the premises of the user and transmitting, via the broadband connection using the fixed wireless access network, the plurality of communications to one or more remote servers.

In some examples, the low-power wide area network includes a low power long-range (LoRa) network. In some implementations, the operations further include receiving, via a smart utility network, a third communication from a utility device and transmitting, via the broadband connection using the fixed wireless access network, the third communication to a second remote server. In these implementations, the smart utility network may include a Wi-SUN network.

Optionally, the customer premises equipment is powered via power over Ethernet (PoE) from the premises of the user. The user device may include a smart home device. In some examples, the operations further include configuring a configurable transceiver to communicate via the low-power wide area network. In some implementations, transmitting the first communication and the second communication to the remote server includes determining an optimal transmit time to minimize interference.

In some examples, the operations further include receiving, via the low-power wide area network, an error condition from a remote customer premises equipment and transmitting, to the remote server, the error condition of a network connected to the remote customer premises equipment using the fixed wireless access network. The operations may further include receiving, via the low-power wide area network, diagnostic information from the low-power device and transmitting, via the fixed wireless access network, to the remote server, the diagnostic information, the diagnostic information, when received by the remote server, configured to cause the remote server to analyze the diagnostic information using a model. Optionally, the second communication is received via software defined radio.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for providing gateways for multiple devices via fixed broadband wireless access customer premises equipment (CPE).

FIG. 2 is a block diagram of example customer premises equipment of the system of FIG. 1.

FIG. 3 is a schematic view of optimizing performance and mitigating interference in the system of FIG. 1.

FIG. 4 is a flowchart of an example arrangement of operations for a method providing fixed broadband wireless access to devices via customer premises equipment with embedded gateways.

FIG. 5 is a schematic view of an example computing device that may be used to implement the systems and methods described herein.

Like reference symbols in the various drawings indicate like elements.

### DETAILED DESCRIPTION

Low-power wide area networks (LPWANs) generally rely on an outdoor sub-gigahertz wireless network. In contrast, many personal area networks (PAN) or home area networks (HAN) such as Wi-Fi wireless networks typically have bad outdoor coverage. These personal networks also operate on very different frequency bands than LPWANs and have different power and bandwidth requirements. Currently, there is no easy or convenient way to tie LPWAN, HAN, and PAN networks together.

More and more “smart” devices are making use of LPWANs to communicate at outdoor locations over long distances. Smart meters, automated sprinklers, and pet trackers are just a few examples of devices that are typically battery operated (and thus have low power requirements) that make use of LPWANs to transmit information. However, the market for these “Internet of Things” (IoT) devices is quite fragmented among many different LPWAN technologies. Among these, Wi-SUN networks and LoRa networks offer two of the most common solutions.

Fixed wireless access (FWA) refers to the offering of internet services through wireless communication devices used to connect two fixed locations such as a tower and a residential building, in place of using a wireline infrastructure to connect a user to a service provider's central office. Fixed wireless access is capable of providing high-speed broadband internet connections. Typically, FWA uses customer premises equipment (CPE) on an exterior portion of the premises (e.g., the roof of a home or business) to connect the end user's home networks to the Internet. That is, for good coverage and wireless signal intensity, the CPE is usually installed outdoor on a roof.

Implementations herein are directed toward CPE mounted at an exterior portion (e.g., a roof) of a user's premises and includes one or more embedded LPWAN gateways for LPWAN networks such as Wi-SUN, LoRa, etc. Additionally, the CPE may include a gateway that connects indoor (i.e., within the building of the CPE) and outdoor IoT devices together. Furthermore, when multiple nearby CPEs each include multiple embedded protocol stack IoT gateways (e.g. CPEs with both Wi-SUN and LoRa gateways), in some examples, in an FWA deployment, the customer premises becomes a crowd-source multi-mode IoT gateway which is configured and optimized through the cloud backend. In some implementations, the LPWAN network forms a mesh out of band management and diagnosis network for the FWA service.

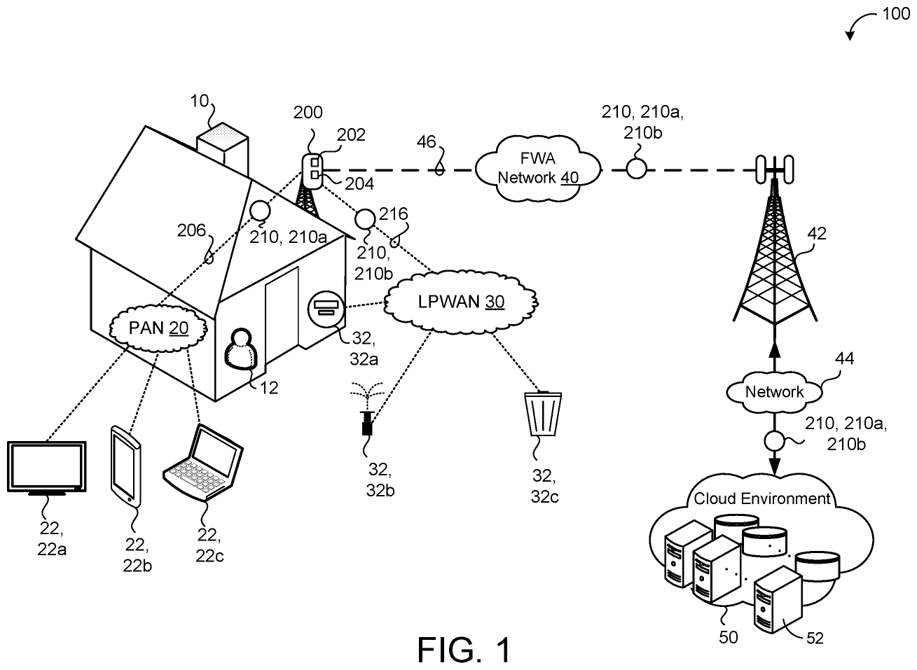

Referring to FIG. 1, in some implementations, an example communication system 100 includes customer premises equipment 200 installed at an exterior portion of a premises 10 of a user 12. Here, the premises 10 is a home or other dwelling of the user 12 and the exterior portion is a roof of the premises 10. However, the premises 10 may encompass any structure and the exterior portion such as a commercial building or a multiple dwelling unit. In addition to various network interfaces and network processing functions, the CPE includes computing resources 202 (e.g., data processing hardware) and/or storage resources 204 (e.g., memory hardware). While examples herein illustrate the CPE 200 mounted at an exterior portion of a premises 10, in some examples, the CPE 200 is within an interior of a premises 10.

The CPE 200 communicates with a PAN 20 located primarily within the premises 10. In some examples, the PAN 20 includes a Wi-Fi network and/or a wired local area network (LAN). The CPE 200 may interface with the PAN 20 via a wireless or a wired connection 206 (e.g., via Wi-Fi or via a wired Ethernet connection). For example, the user 12 maintains a Wi-Fi network via an access point (AP) which communicates with a switch and/or router. The switch or router provides a wired Ethernet connection to the CPE 200. The user 12 may connect any number of user devices 22, 22a-c to the PAN 20. The user devices 22 may include smart home devices. Here, the user has connected a smart TV 22, 22a; a mobile phone 22, 22b; and a laptop computer 22, 22c to the PAN via wireless or wired connections. Thus, each of these user devices 22 may communicate with the CPE 200 via the connection 206. That is, the CPE 200 receives communications 210, 210a from one or more user devices 22 located within the interior of the premises 10 of the user 12.

The CPE 200 also includes a connection 216 to one or more LPWANs 30. For example, one LPWAN 30 is a LoRa network. The LPWAN 30 may include a smart utility network. For instance, one LPWAN 30 is a Wi-SUN smart utility network. Each LPWAN 30 connects one or more low-power devices 32, 32a-c. Here, the lower-power devices 32 include a smart meter 32, 32a; a sprinkler 32, 32b; and a waste receptacle 32, 32c. While some of these low-power devices 32 may be located within the premises 10 of the user 12 (e.g., security system sensors), many low-power devices 32 are exterior of the premises 10 (i.e., are outdoors) and thus must rely on the LPWAN 30 to communicate. These low-power devices 32 typically have strict power requirements as they often operate on a battery. However, the low-power devices 32 also typically have low bandwidth requirements. The CPE 200 receives communications 210, 210b from the one or more low-power devices 32 located exterior of the premises of the user 12.

The CPE 200 provides a FWA connection 46 to a fixed tower 42 or other structure (e.g., another building) via a FWA network 40. The tower 42 includes, for example, a macrocell (i.e., a macro cellular base station) that provides a wireless broadband connection to the CPE 200 (e.g., via a 5G base station network). The CPE 200 and the tower 42 may communicate using directional antennas and beamforming technologies to maximize coverage and performance. The tower 42, via a network 44, provides access to a cloud environment 50 (i.e., the Internet) that includes a remote server 52. The CPE 200 transmits, via the broadband connection 46 using the FWA network, the communications 210a from the user devices 22 and the communications 210b from the low-power devices 32 to one or more remote servers 52. Thus, the CPE 200 simultaneously provides Internet access to both user devices 22 interior of the premises 10 and low-power devices 32 exterior of the premises 10.

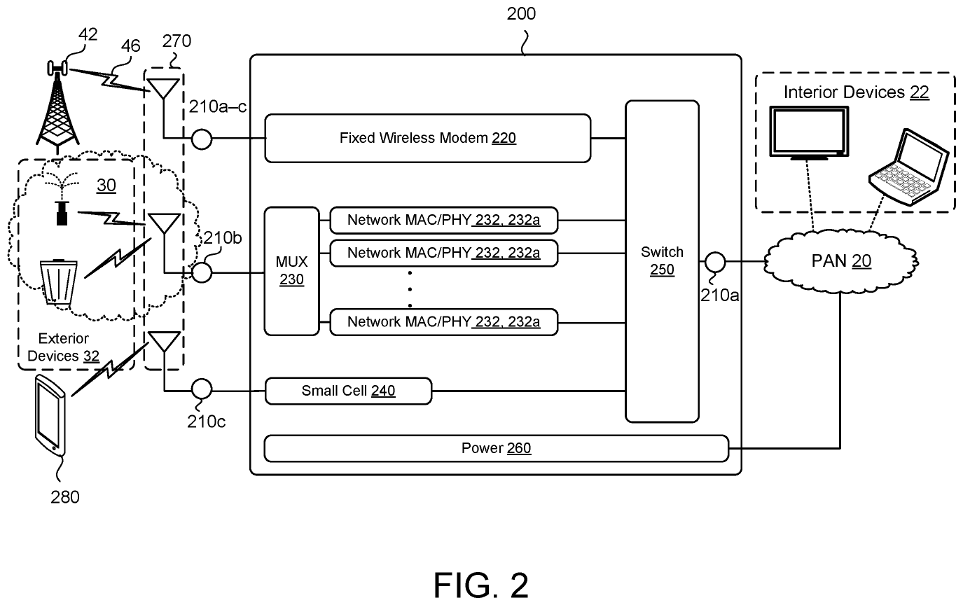

Referring now to FIG. 2, in some implementations, the CPE 200 includes a fixed wireless modem 220 for communicating with the tower 42. For example, the fixed wireless modem 220 is a Citizens Broadband Radio System (CBRS), a 6 GHz, or a C-band modem. The fixed wireless modem 220 may connect with a switch 250 that routes communications 210 between the PAN 20, the LPWAN(s) 30, and the tower 42. The CPE 200 includes one or more antennas 270 for receiving and transmitting communications. The antennas 270 may be any shape, size, or orientation. The antennas 270 may include antenna arrays and in some examples the antennas 270 are adjustable. In some implementations, the CPE 200 includes beamforming technologies.

In some examples, the CPE 200 includes a multiplexor (i.e., a mux) 230 connected to one or more network MAC/PHYs 232, 232a-n. For example, the CPE 200 includes a LoRa MAC/PHY 232, a Wi-SUN MAC/PHY 232, and/or a software defined radio (SDR) MAC/PHY 232. The CPE 200 may include any number of MAC/PHYs 232 to support any number of different network technologies (e.g., LPWAN technologies). The mux 230 may provide time division multiplexing among two or more MAC/PHYs 232. For example, the data processing hardware 202 may control the mux 230 so that each MAC/PHY 232 may communicate with respective exterior devices 32 for non-overlapping discrete portions of time. In some examples, two or more LPWANs 30 share unlicensed frequency bands (e.g., 915 MHz) and the mux 230 may reduce interference and/or collisions among the different LPWANs 30. Each network MAC/PHY 232 connects with the switch 250. The switch 250 also receives a connection from the PAN 20 (e.g., via a wired Ethernet connection). Thus, communications 210a from the user devices 22 have access to the broadband connection 46 over the PAN 20 and communications 210b from the low-power devices 32 also have access to the broadband connection 46 over the LPWAN 30 via the switch 250.

Thus, the CPE 200 may receive a plurality of communications 210b, via one or more LPWANs 30, from a plurality of different low-power devices 32 located exterior of the premises 10 of the user 12. The CPE 200 may transmit, via the broadband connection 46 using the FWA network 40, the plurality of communications 210b to one or more remote servers 52. In some implementations, one or more of the LPWANs in communication with the CPE 200 is a smart utility network such as a Wi-SUN network. In this scenario, the CPE 200 receives, via the smart utility network, a communication 210 from a utility device 32 (e.g., a smart meter) and transmits, via the broadband connection 46 using the FWA network 40, the communication 210b from the utility device 32 to a remote server 52.

In some examples, the switch 250 allows the exterior devices 32 to directly communicate with the user devices 22 connected via the PAN 20 via the switch 250 without routing through a backend cloud service via the broadband connection 46. Only approved (e.g., via a whitelist or other authentication/authorization methods) low-power devices 32 may directly access the PAN 20. In some examples, the CPE 200 communicates with a first set of low-power devices 32 that are associated with and/or controlled by the user 12 and a second set of low-power devices 32 that are not associated with the user 12 (i.e., not owned, controlled, or managed by the user 12). In this scenario, the first set of low-power devices 32 may be authorized to communicate with the user devices 22 (via the PAN 20) directly (i.e., without going through a cloud backend) while the second set of low-power devices are not authorized to communicate directly with the user devices 22 or the PAN 20. In other implementations, all low-power devices 32, regardless of whether they are associated with the user 12 or not, are not authorized to communicate the user devices 22 and PAN 20 directly and instead may only communicate via a cloud backend over the broadband connection 46.

In some examples, the CPE 200 includes a small cell 240. The small cell 240 is a low-powered cellular radio access node that is capable of extending the mobility of nearby mobile devices such as mobile telephones. Here, the small cell 240 provides nearby mobile devices 280 (interior or exterior of the premises 10) cellular and/or data coverage. The mobile devices 280 may not be associated in any way with the user 12 or the premises 10, but instead extend mobility to all compatible mobile devices 280 within the range of the small cell 240. In this manner, an operator offering the FWA service makes use of the CPEs 200 to expand or improve the operator's footprint and signal coverage. In some examples, an operator of the CPE 200 and the FWA network 40 enables operators of other networks access to the FWA network 40 via the small cell 240. For example, a user device (e.g., a cell phone) associated with an operator that is independent of the operator of the CPE 200 may communicate with the CPE 200 via the small cell 240 and the CPE 200 may route traffic to and from the user device via the FWA network 40. In this way, the operator of the CPE 200 may serve as a neutral hose that leases or rents or provides access to the FWA network 40 (e.g., for revenue generation).

In some implementations, the CPE 200 includes a power module 260. The CPE 200 may be powered via power over Ethernet (PoE), such as via the Ethernet connection to the PAN 20. Additionally or alternatively, the CPE 200 is powered via an independent power supply (such as via a power outlet located on or within the premises 10).

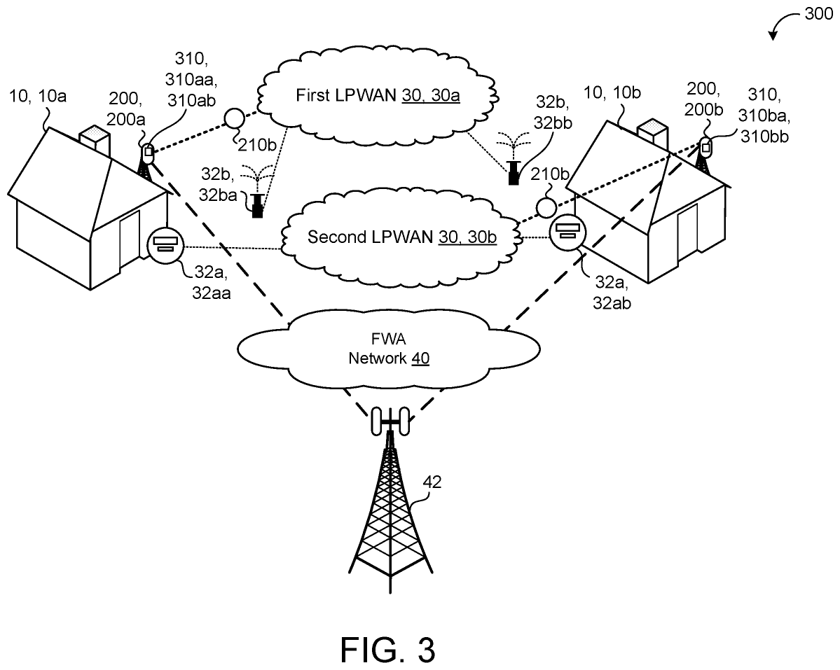

Referring now to FIG. 3, in some implementations, the CPE 200 includes one or more configurable transceivers 310 that send and receive communications 210b to and from the LPWANs 30. The operator of the FWA service (e.g., via the FWA network 40) and/or the user 12 (e.g., via the PAN 20) and/or one or more remote servers 52 may configure the transceivers based on the low-power devices 32 within range of the CPE 200 and/or based on other nearby CPEs 200. In the given example, a first premises 10, 10a includes a first CPE 200, 200a with a first configurable transceiver 310, 310aa and a second configurable transceiver 310, 310ab. The first configurable transceiver 310aa communicates with low-power devices 32 via a first LPWAN 30, 30a (e.g., a LoRa network) and the second configurable transceiver 310ab communicates with low-power devices 32 via a second LPWAN 30, 30b (e.g., a Wi-SUN network). Similarly, a second premises 10, 10b includes a second CPE 200, 200b with a first configurable transceiver 310, 310ba for communicating with the first LPWAN 30a and a second configurable transceiver 310, 310bb for communicating with the second LPWAN 30b.

In some examples, when either of the CPEs 200a, 200b are not within range of any low-power devices 32 communicating via the first LPWAN 30a (e.g., there are no devices communicating via LoRa within range), one or both of the CPEs 200a, 200b disable their respective first configurable transceiver 310aa, 310ba. Alternatively or additionally, when either of the CPEs 200a, 200b are not within range of any low-power devices 32 communicating via the second LPWAN 30b (e.g., there are no devices communicating via Wi-SUN within range), one or both of the CPEs 200a, 200b disable their respective second configurable transceiver 310ba, 310bb.

In the example shown in FIG. 3, schematic view 300 includes low-power devices 32 within range of both the first premises 10a and the second premises 10b that communicate via the first LPWAN 30a and there are low-power devices 32 within range of both the first premises 10a and the second premises 10b that communicate via the second LPWAN 30b. Here, a first smart meter 32a, 32aa and a second smart meter 32a, 32ab are both within range of the same second LPWAN 30b while a first sprinkler 32b, 32ba and a second sprinkler 32b, 32bb are within range of the first LPWAN 30a. In some implementations, the first CPE 200a disables its second configurable transceiver 310ab and both the first smart meter 32aa and the second smart meter 32ab communicate with the second CPE 200b. The second CPE 200b may disable its first configurable transceiver 310ba and both the first sprinkler 32ba and the second sprinkler 32bb communicate with the first CPE 200a. That is, the CPEs 200 may configure their respective transceivers 310 based on the proximity of low-power devices 32 and/or other CPEs 200 to reduce or mitigate interference. In some examples, a common cloud entity (i.e., one or more remote servers 52) optimizes the configuration of the transceivers 310 of a plurality of CPEs 200.

In some implementations, the CPEs 200 (and/or the remote servers 52) determine an optimal transmit time to transmit the communications 210b in order to minimize interference between low-power devices 32 and/or other CPEs 200. For example, the CPEs 200 and/or remote server(s) 52 may assign the lower-power devices 32 and/or CPEs 200 transmit time slots to reduce collisions and interference. In some examples, the cloud environment (e.g., one or more remote servers 52) has visibility of a plurality of CPEs 200. The cloud environment using, for example, geo-data, may optimize the LPWANs by scheduling transmissions to and/or from the exterior devices 32.

In some examples, the CPE 200 receives, via one of the LPWANs 30, a communication from a different remote CPE 200. That is, one CPE 200 may communicate with another CPE 200 via one or more LPWANs 30. The communication may include an error condition of a network that the transmitting CPE 200 is connected to. For example, when the broadband connection for a respective CPE 200 fails, the CPE 200 may communicate the error condition to another CPE 200. That CPE 200 may transmit the error condition to the cloud environment via the FWA network 40. Alternatively, the CPE 200 (e.g., when the first CPE 200 is also experiencing broadband connection issues) may forward the error condition on to another CPE 200 and so on until a CPE 200 with an operational broadband connection is able to communicate the error conditions to the cloud environment. In this way, the CPEs, using the LPWANs 30, may form an LPWAN mesh network and an out-of-band diagnostic network. The CPEs 200 may communicate diagnostic information (in addition to or alternative to the error condition) to the remote servers 52 (e.g., to remote servers 52 associated with the operator of the FWA network 40). The diagnostic information may allow the operator to determine actions to mitigate network issues (e.g., the operator may attempt to reboot or reset one or more CPEs 200, dispatch repair teams, etc.).

Optionally, the CPE 200 receives, from one or more exterior devices 32, via the LPWANs 30, diagnostic information (e.g., temperature readings, humidity readings, etc.). The CPE 200 may transmit this exterior device diagnostic information to one or more remote servers for analysis via the FWA network 40 or via the LPWAN mesh network. The remote servers 52 may analyze the diagnostic information (e.g., using a model such as a machine learning algorithm or neural network) from CPEs 200 and/or exterior devices 32 to help mitigate network issues.

The remote server 52 may update the user 12 of a status of the FWA network 40 via the LPWANs 30, and applications executing on, for example, the user devices 22. In some implementations, the machine learning model diagnoses issues with the FWA network 40 via the plurality of communications 210b to reduce outage times.

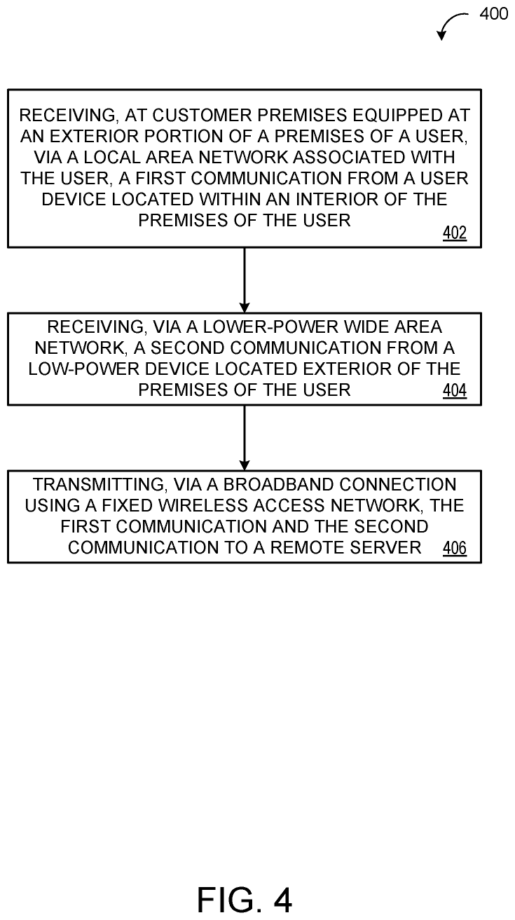

FIG. 4 is a flowchart of an example method 400 for providing gateways for multiple devices via a FWA access CPE. The method 400 includes, at operation 402, receiving, at data processing hardware 202 of CPE 200 installed at an exterior portion of a premises 10 of a user 12, via a PAN 20 associated with the user 12, a first communication 210a from a user device 22 located within an interior of the premises 10 of the user 12. The method 400, at operation 404, includes receiving, at the data processing hardware 202, via a LPWAN 30, a second communication 210b from a low-power device 32 located exterior of the premises 10 of the user 12. At operation 406, the method 400 includes transmitting, by the data processing hardware 202, via a broadband connection 46 using a FWA network 40, the first communication 210a and the second communication 210b to a remote server 52.

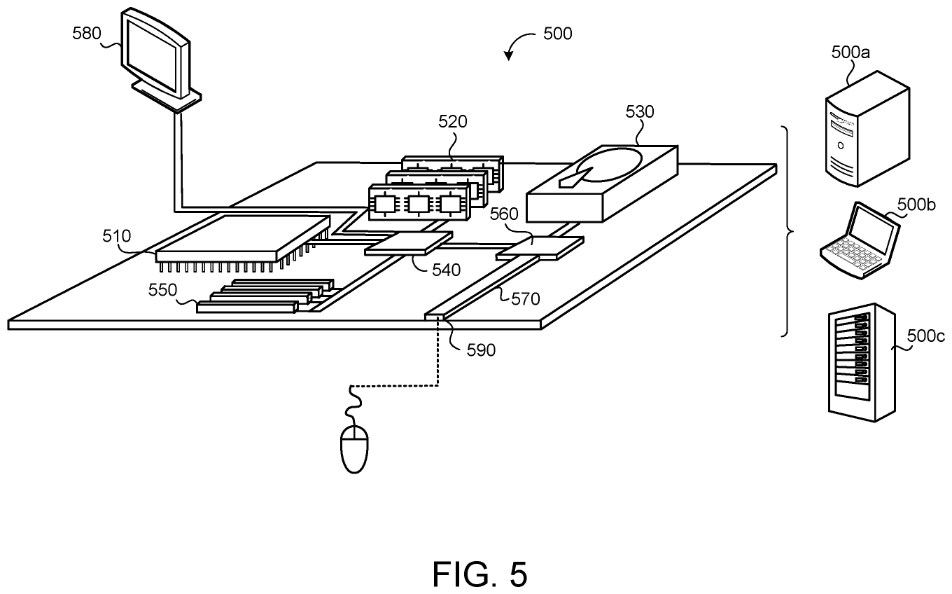

FIG. 5 is schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method when executed by data processing hardware of customer premises equipment installed at an exterior portion of a premises of a user causes the data processing hardware to perform operations comprising:
receiving, via a local area network associated with the user, a first communication from a user device located within an interior of the premises of the user;
receiving, via a low-power wide area network, a second communication from a low-power device located exterior of the premises of the user; and
transmitting, via a broadband connection using a fixed wireless access network, the first communication and the second communication to a remote server.

2. The method of claim 1, wherein the fixed wireless access network comprises a 5G baseline network.

3. The method of claim 1, wherein the operations further comprise:
receiving, via the low-power wide area network, a plurality of communications from a plurality of low-power devices located exterior of the premises of the user; and
transmitting, via the broadband connection using the fixed wireless access network, the plurality of communications to one or more remote servers.

4. The method of claim 1, wherein the low-power wide area network comprises a low power long-range (LoRa) network.

5. The method of claim 1, wherein the operations further comprise:
receiving, via a smart utility network, a third communication from a utility device; and
transmitting, via the broadband connection using the fixed wireless access network, the third communication to a second remote server.

6. The method of claim 5, wherein the smart utility network comprises a Wi-SUN network.

7. The method of claim 1, wherein the customer premises equipment is powered via power over Ethernet (PoE) from the premises of the user.

8. The method of claim 1, wherein the user device comprises a smart home device.

9. The method of claim 1, wherein the operations further comprise configuring a configurable transceiver to communicate via the low-power wide area network.

10. The method of claim 1, wherein transmitting the first communication and the second communication to the remote server comprises determining an optimal transmit time to minimize interference.

11. The method of claim 1, wherein the operations further comprise:
receiving, via the low-power wide area network, an error condition from a remote customer premises equipment; and
transmitting, to the remote server, the error condition of a network connected to the remote customer premises equipment using the fixed wireless access network.

12. The method of claim 1, wherein the operations further comprise:
receiving, via the low-power wide area network, diagnostic information from the low-power device; and
transmitting, via the fixed wireless access network, to the remote server, the diagnostic information, the diagnostic information, when received by the remote server, configured to cause the remote server to analyze the diagnostic information using a model.

13. The method of claim 1, wherein the second communication is received via software defined radio.

14. A system comprising:
data processing hardware of customer premises equipment installed at an exterior portion of a premises of a user; and
memory hardware in communication with the data processing hardware, the memory hardware storing instructions that when executed on the data processing hardware cause the data processing hardware to perform operations comprising:
receiving, via a local area network associated with the user, a first communication from a user device located within an interior of the premises of the user;
receiving, via a low-power wide area network, a second communication from a low-power device located exterior of the premises of the user; and
transmitting, via a broadband connection using a fixed wireless access network, the first communication and the second communication to a remote server.

15. The system of claim 14, wherein the fixed wireless access network comprises a 5G baseline network.

16. The system of claim 14, wherein the operations further comprise:
receiving, via the low-power wide area network, a plurality of communications from a plurality of low-power devices located exterior of the premises of the user; and
transmitting, via the broadband connection using the fixed wireless access network, the plurality of communications to one or more remote servers.

17. The system of claim 14, wherein the low-power wide area network comprises a low power long-range (LoRa) network.

18. The system of claim 14, wherein the operations further comprise:
receiving, via a smart utility network, a third communication from a utility device; and
transmitting, via the broadband connection using the fixed wireless access network, the third communication to a second remote server.

19. The system of claim 18, wherein the smart utility network comprises a Wi-SUN network.

20. The system of claim 14, wherein the customer premises equipment is powered via power over Ethernet (PoE) from the premises of the user.

21. The system of claim 14, wherein the user device comprises a smart home device.

22. The system of claim 14, wherein the operations further comprise configuring a configurable transceiver to communicate via the low-power wide area network.

23. The system of claim 14, wherein transmitting the first communication and the second communication to the remote server comprises determining an optimal transmit time to minimize interference.

24. The system of claim 14, wherein the operations further comprise:
receiving, via the low-power wide area network, an error condition from a remote customer premises equipment; and
transmitting, to the remote server, the error condition of a network connected to the remote customer premises equipment using the fixed wireless access network.

25. The system of claim 14, wherein the operations further comprise:
receiving, via the low-power wide area network, diagnostic information from the low-power device; and
transmitting, via the fixed wireless access network, to the remote server, the diagnostic information, the diagnostic information, when received by the remote server, configured to cause the remote server to analyze the diagnostic information using a model.

26. The system of claim 14, wherein the second communication is received via software defined radio.
